(19) United States
(12) Patent Application Publication
(10) Pub. No.: US 2019/0361478 A1
(43) Pub. Date: Nov. 28, 2019

(54) KNOB ASSEMBLY AND SHUTTLE KNOB INCLUDING THE SAME

(71) Applicant: PEGATRON CORPORATION, TAIPEI CITY (TW)

(72) Inventors: Long-Sing YE, TAIPEI CITY (TW); Tao-Hsiang TANG, TAIPEI CITY (TW)

(21) Appl. No.: 16/378,738

(22) Filed: Apr. 9, 2019

(30) Foreign Application Priority Data
May 24, 2018 (TW) 107206859

(51) Int. Cl. G05G 1/12; H01H 19/14; H01H 3/08

(52) U.S. Cl. CPC G05G 1/12; H01H 3/08; H01H 19/14

(57) ABSTRACT

A knob assembly includes a disk housing body and an annular base. The disk housing body includes a cover plate, a limiting structure, and a side wall structure. The cover plate and the limiting structure are disposed opposite to each other. The side wall structure is connected to the cover plate and the limiting structure to form a horizontal annular groove. The annular base is embedded in the horizontal annular groove, so that the disk housing body can rotate relative to the annular base. A shuttle knob includes the foregoing knob assembly, a substrate, a reflection layer, and a detection apparatus. The knob assembly is disposed on the substrate by using the annular base. The reflection layer is disposed between the disk housing body and the annular base, and the reflection layer includes a feature pattern. The detection apparatus is disposed on the substrate.

### CROSS-REFERENCE TO RELATED APPLICATION

This non-provisional application claims priority under 35 U.S.C. § 119(a) to Patent Application No. 107206859 filed in Taiwan, R.O.C. on May 24, 2018, the entire contents of which are hereby incorporated by reference.

### BACKGROUND

### Field of Invention

The application relates to a shuttle knob, and in particular, to a shuttle knob including a knob assembly.

### Description of Related Art

Generally, a shuttle is a device configured to guide a user to listen to/view audio or video content. Usually, with rotation of the shuttle, a medium deflects (for example, fast forwards or rewinds, or goes leftward or rightward) in one direction according to a rotation manner. For example, if the user rotates the shuttle clockwise, the medium generally moves forward. On the contrary, if the user rotates the shuttle anticlockwise, the medium generally rewinds.

In addition, the shuttle is also applied to a mouse of a computer as a scroll rotating disk. Moreover, the shuttle rotating disk is also applied to, for example, a personal digital assistant, a music player, or various other electronic devices, to serve as a selection interface of a menu.

### SUMMARY

According to an implementation of the disclosure, a knob assembly includes a disk housing body and an annular base. The disk housing body includes a cover plate, a limiting structure, and a side wall structure. The cover plate and the limiting structure are disposed opposite to each other. The side wall structure is connected to the cover plate and the limiting structure to form a horizontal annular groove. The annular base is embedded in the horizontal annular groove, so that the disk housing body is capable of rotating relative to the annular base.

In one or more implementations of the disclosure, a shuttle knob includes a substrate, a detection apparatus, a knob assembly, and a reflection layer. The detection apparatus is disposed on the substrate. The knob assembly includes a disk housing body and an annular base. The disk housing body includes a cover plate, a limiting structure, and a side wall structure. The cover plate and the limiting structure are disposed opposite to each other. The side wall structure is connected to the cover plate and the limiting structure to form a horizontal annular groove. The annular base is embedded in the horizontal annular groove, so that the disk housing body is capable of rotating relative to the annular base. The knob assembly is disposed on the substrate by using the annular base. The reflection layer is disposed between the disk housing body and the annular base, and the reflection layer includes a feature pattern. The detection apparatus is configured to detect the feature pattern.

In one or more implementations of the disclosure, the foregoing disk housing body includes a first disk housing body portion and a second disk housing body portion. The first disk housing body portion and the second disk housing body portion are both C-shaped. The first disk housing body portion includes one part of the cover plate, one part of the limiting structure, and one part of the side wall structure. The second disk housing body portion includes the other part of the cover plate, the other part of the limiting structure, and the other part of the side wall structure. The first disk housing body portion and the second disk housing body portion are detachably combined into the disk housing body.

In one or more implementations of the disclosure, the cover plate of the foregoing disk housing body includes one slot, so that oil is capable of flowing into the disk housing body through the slot.

In one or more implementations of the disclosure, a surface that is of the limiting structure of the foregoing disk housing body and that faces the annular base includes at least one protruding rib. The limiting structure is in slidable contact with the annular base by using the at least one protruding rib.

In one or more implementations of the disclosure, a surface that is of the cover plate of the foregoing disk housing body and that faces the annular base includes at least one protruding rib. The cover plate is in slidable contact with the annular base by using the at least one protruding rib.

In one or more implementations of the disclosure, the foregoing disk housing body is a hollow sheet-like disk housing body. The annular base is a hollow sheet-like annular base.

In one or more implementations of the disclosure, the annular base of the foregoing knob assembly has an opening. The detection apparatus detects the feature pattern through the opening.

In one or more implementations of the disclosure, the reflection layer of the foregoing shuttle knob is an annular structure.

In conclusion, in the application, the annular base is embedded in the horizontal annular groove of the disk housing body, so that assembly of the knob assembly can be completed, and further the two working members, namely, the annular base and the disk housing body are enabled to rotate relative to each other without an additional assembly element. In this way, costs and assembly time of the knob assembly and the shuttle knob are reduced.

### BRIEF DESCRIPTION OF THE DRAWINGS

To make the foregoing descriptions, other objectives, features, advantages and embodiments of the disclosure more comprehensible, descriptions of the accompanying drawings are as follows.

FIG. 1 is a three-dimensional view of a shuttle knob according to an implementation of the disclosure.

FIG. 2 is an exploded view of the shuttle knob shown in FIG. 1.

FIG. 3A and FIG. 3B are respectively a three-dimensional top view and a three-dimensional bottom view of a knob assembly according to an implementation of the disclosure.

FIG. 4A is a sectional view taken along a line A-A of the knob assembly shown in FIG. 3A.

FIG. 4B is a sectional view taken along the line A-A of an annular base in the knob assembly shown in FIG. 3A.

FIG. 4C is a sectional view taken along the line A-A of a disk housing body in the knob assembly shown in FIG. 3B.

FIG. 5A is a three-dimensional view of an upper cover, a disk housing body, and a reflection layer.

FIG. 5B is a three-dimensional view of an annular base, a detection apparatus, a substrate, and a base.

### DETAILED DESCRIPTION

The following descriptions provide a plurality of different implementations or embodiments to implement a theme of the disclosure. Specific examples of elements or arrangement are discussed below to simplify the disclosure. Certainly, the descriptions are only some examples and the disclosure is not limited thereto. For example, a first feature is formed on or above a second feature. The description not only includes an implementation in which the first feature is in direct contact with the second feature, but also includes an implementation in which another feature is formed between the first feature and the second feature, so that the first feature is not in direct contact with the second feature. In addition, the disclosure may repeat numerals or characters in different examples. The repetition is for brief and accurate description, rather than defining relationships between the discussed different implementations and configurations.

In addition, spatial relative terms such as ‘under’, ‘below’, ‘lower than’, ‘on’, “above”, and other similar terms herein are for ease of description of a relationship between one element or feature and another element or feature in the figures. In addition to orientations drawn in the figures, the spatial relative terms further include another orientation when an apparatus is used or operated. In other words, when an orientation of the apparatus is different (rotated by 90 degrees or at the another orientation) from that in the figures, the spatial relative terms used in the specification can also be correspondingly interpreted.

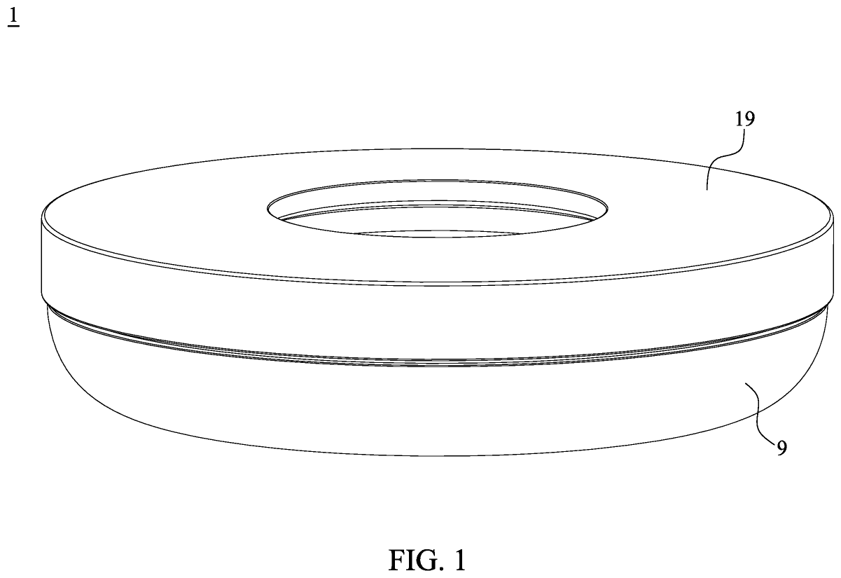

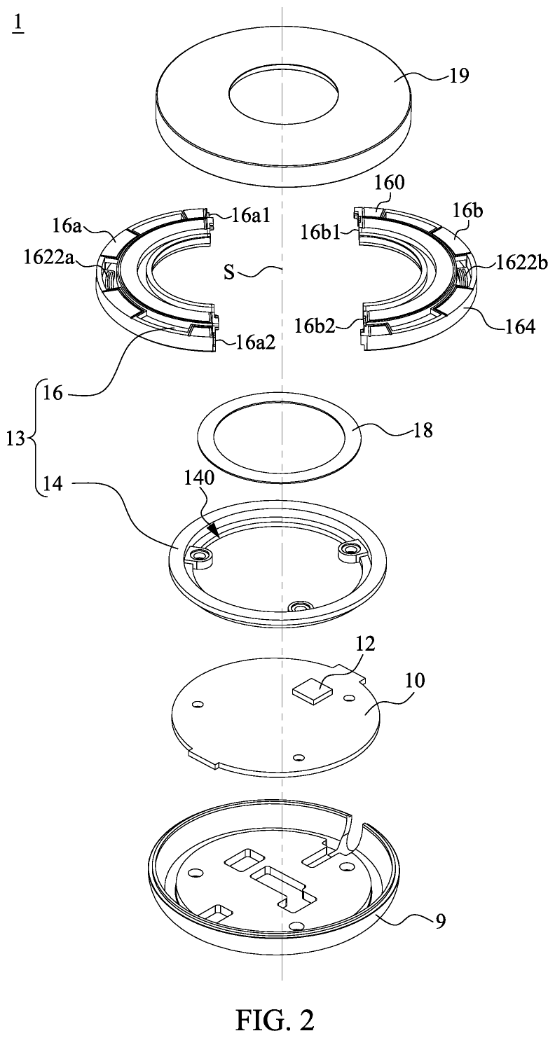

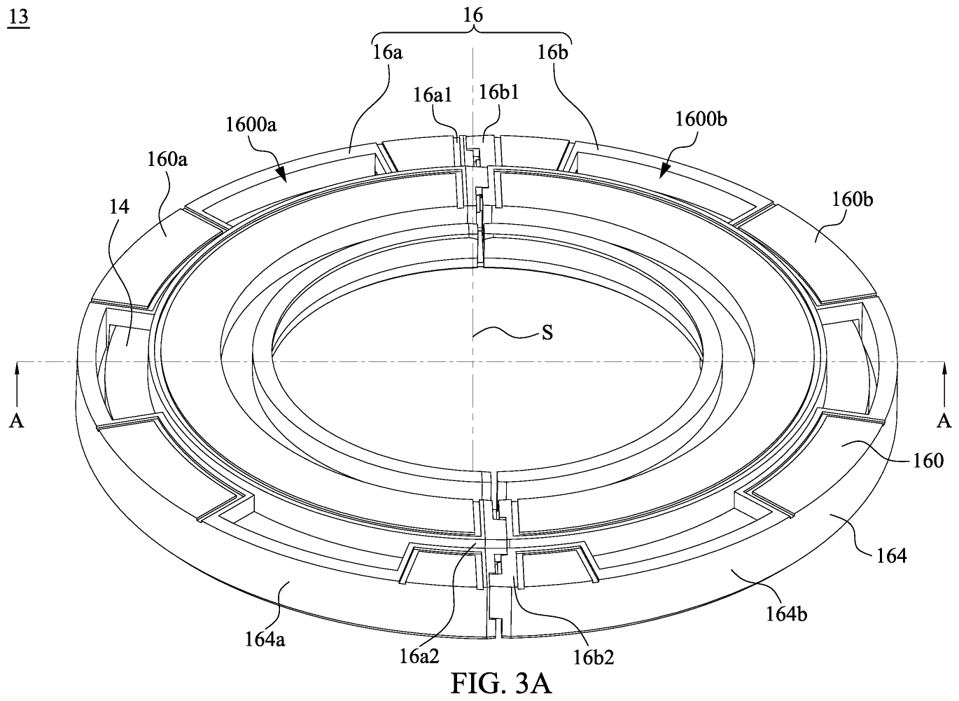

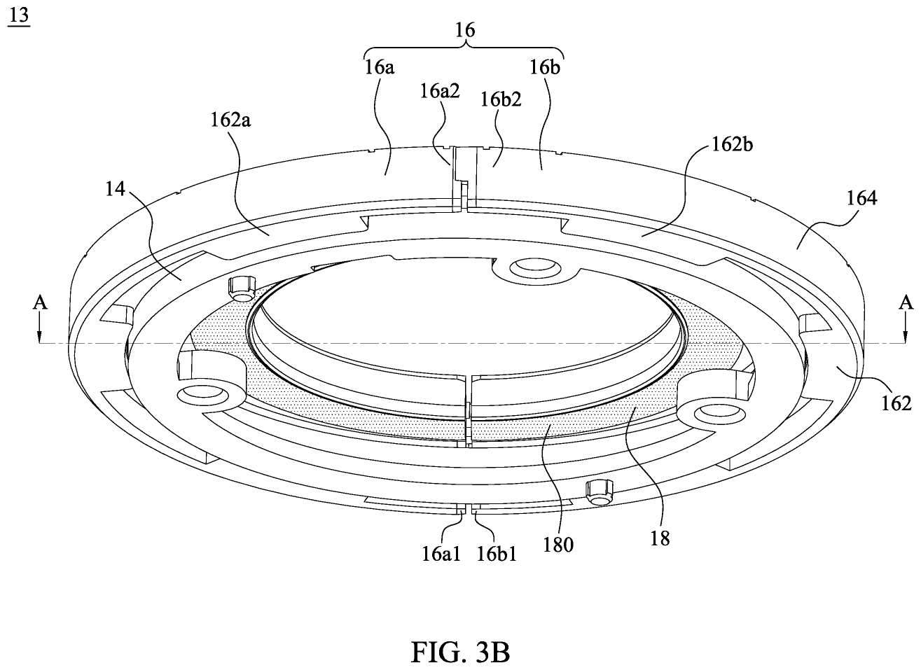

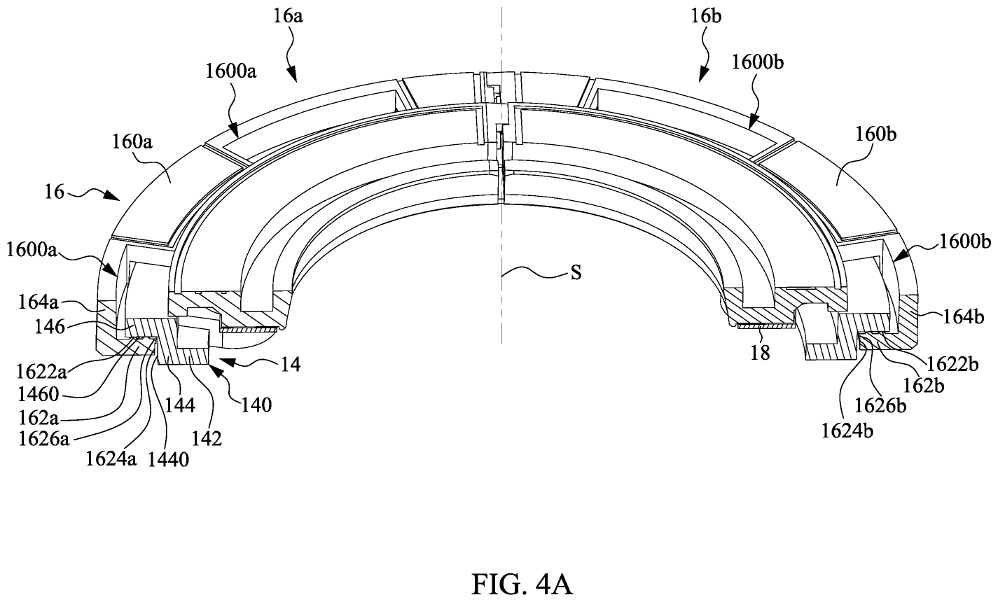

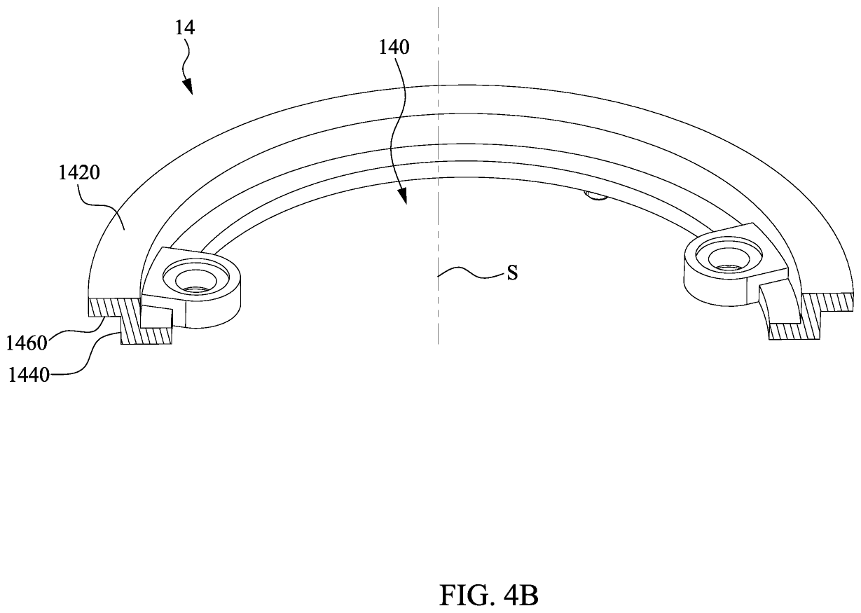

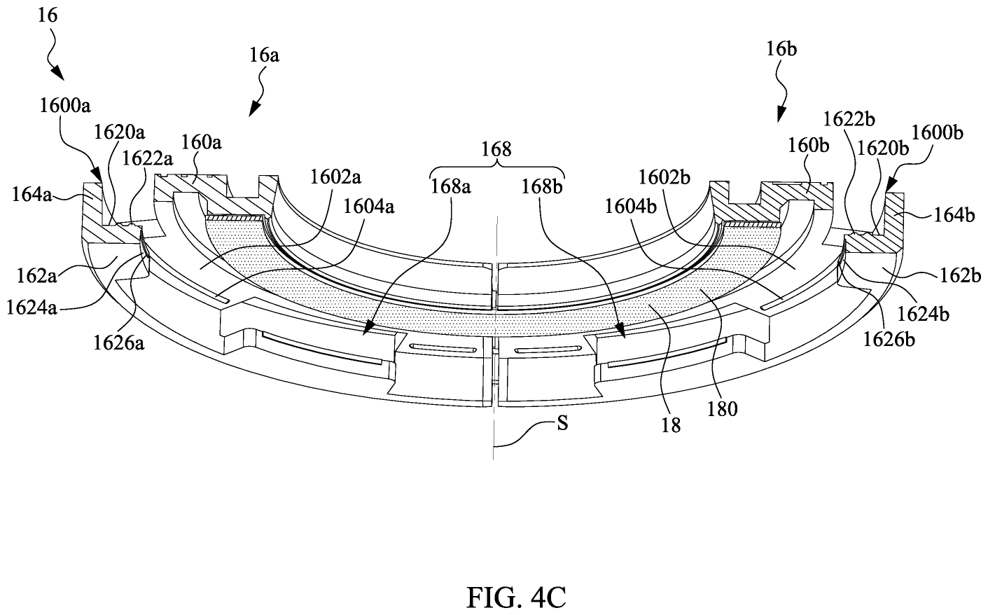

Refer to FIG. 1 to FIG. 4C. FIG. 1 is a three-dimensional view of a shuttle knob 1 according to an implementation of the disclosure. FIG. 2 is an exploded view of the shuttle knob 1 shown in FIG. 1. FIG. 3A and FIG. 3B are respectively a three-dimensional top view and a three-dimensional bottom view of a knob assembly 13 according to an implementation of the disclosure. FIG. 4A is a sectional view taken along a line A-A of the knob assembly 13 shown in FIG. 3A. FIG. 4B is a sectional view taken along the line A-A of an annular base 14 in the knob assembly 13 shown in FIG. 3A. FIG. 4C is a sectional view taken along the line A-A of a disk housing body 16 in the knob assembly 13 shown in FIG. 3B.

In this implementation, the shuttle knob 1 includes a base 9, a substrate 10, a detection apparatus 12, the knob assembly 13, a reflection layer 18, and an upper cover 19.

First refer to FIG. 2 to FIG. 4C. The following describes structures and functions of elements included in the knob assembly 13 of the shuttle knob 1 and connection relationships between the elements in detail. The knob assembly 13 includes the annular base 14 and the disk housing body 16. The disk housing body 16 includes a cover plate 160, a limiting structure 162, and a side wall structure 164. The cover plate 160 and the limiting structure 162 are disposed opposite to each other. The side wall structure 164 is connected to the cover plate 160 and the limiting structure 162 to form a horizontal annular groove 168. The annular base 14 is embedded in the horizontal annular groove 168, so that the disk housing body 16 is capable of rotating relative to the annular base 14 along a rotating shaft S.

In this embodiment, the disk housing body 16 includes a first disk housing body portion 16a and a second disk housing body portion 16b, and the first disk housing body portion 16a and the second disk housing body portion 16b are detachably combined into the disk housing body 16. The first disk housing body portion 16a and the second disk housing body portion 16b of the disk housing body 16 are both C-shaped. Specifically, as shown in FIG. 3A and FIG. 3B, the first disk housing body portion 16a includes a first end portion 16a1 and a second end portion 16a2 opposite to each other, and the second disk housing body portion 16b includes a first end portion 16b1 and a second end portion 16b2 opposite to each other. The first end portion 16a1 of the first disk housing body portion 16a is connected to the first end portion 16b1 of the second disk housing body portion 16b, and the second end portion 16a2 of the first disk housing body portion 16a is connected to the second end portion 16b2 of the second disk housing body portion 16b. In some implementations, a connection manner between the first disk housing body portion 16a and the second disk housing body portion 16b may be fixing the first disk housing body portion 16a and the second disk housing body portion 16b together by using an adhesive. Alternatively, a connection manner between the first disk housing body portion 16a and the second disk housing body portion 16b may be combining the first disk housing body portion 16a and the second disk housing body portion 16b through engagement into the disk housing body 16 by using a concavo-convex structure. However, the application is not limited thereto.

The first disk housing body portion 16a of the disk housing body 16 includes a first cover plate portion 160a, a first limiting portion 162a, and a first side wall portion 164a. The first side wall portion 164a is connected to the first cover plate portion 160a and the first limiting portion 162a. The first side wall portion 164a, the first cover plate portion 160a, and the first limiting portion 162a form a first horizontal annular groove portion 168a. One part of the annular base 14 is embedded in the first horizontal annular groove portion 168a.

In this implementation, as shown in FIG. 4C, the first cover plate portion 160a of the first disk housing body portion 16a has a surface 1602a. The surface 1602a faces toward the first limiting portion 162a and faces the annular base 14. The surface 1602a includes at least one protruding rib 1604a. The protruding rib 1604a protrudes toward the first limiting portion 162a.

In this implementation, the first limiting portion 162a of the first disk housing body portion 16a has a surface 1620a (as shown in FIG. 4A and FIG. 4C) facing toward the first cover plate portion 160a, and the surface 1620a faces the annular base 14. The first limiting portion 162a also includes a surface 1624a (as shown in FIG. 4A and FIG. 4C) facing the rotating shaft S. The surface 1620a includes at least one protruding rib 1622a protruding toward the first cover plate portion 160a. The surface 1624a includes at least one protruding rib 1626a protruding toward the rotating shaft S. In this implementation, the first cover plate portion 160a of the first disk housing body portion 16a includes a first slot 1600a, so that oil is capable of flowing into the disk housing body 16 through the first slot 1600a, to enable the disk housing body 16 and the annular base 14 to more smoothly rotate relative to each other, and reduce friction. The oil may be oil for lubrication.

The second disk housing body portion 16b of the disk housing body 16 includes a second cover plate portion 160b, a second limiting portion 162b, and a second side wall portion 164b. The second side wall portion 164b is connected to the second cover plate portion 160b and the second limiting portion 162b. The second side wall portion 164b, the second cover plate portion 160b, and the second limiting portion 162b form a second horizontal annular groove portion 168b. The other part of the annular base 14 is embedded into the second horizontal annular groove portion 168b.

Refer to both FIG. 2 and FIG. 4A. For example, in an assembly process of the knob assembly 13, the annular base 14 is embedded in the first horizontal annular groove portion 168a of the first disk housing body portion 16a and the second horizontal annular groove portion 168b of the second disk housing body portion 16b, and then the first end portion 16a1 and the second end portion 16a2 of the first disk housing body portion 16a are respectively connected to the first end portion 16b1 and the second end portion 16b2 of the second disk housing body portion 16b, so that assembly of the knob assembly 13 may be completed. In this implementation, the disk housing body 16 is configured to rotate relative to the annular base 14 along the rotating shaft S. In this way, the knob assembly 13 in this implementation can enable other elements respectively connected to the annular base 14 and the disk housing body 16 to rotate relative to each other without an additional assembly element. In this way, costs and assembly time of the knob assembly 13 and the shuttle knob 1 are reduced.

As shown in FIG. 4A, the first cover plate portion 160a of the first disk housing body portion 16a and the second cover plate portion 160b of the second disk housing body portion 16b form the cover plate 160 (as shown in FIG. 3A and FIG. 3B) of the disk housing body 16. The first limiting portion 162a of the first disk housing body portion 16a and the second limiting portion 162b of the second disk housing body portion 16b form the limiting structure 162 (as shown in FIG. 3A and FIG. 3B) of the disk housing body 16. The first side wall portion 164a of the first disk housing body portion 16a and the second side wall portion 164b of the second disk housing body portion 16b form the side wall structure 164 (as shown in FIG. 3A and FIG. 3B) of the disk housing body 16. It can be learned that the side wall structure 164 of the disk housing body 16 is connected between the cover plate 160 and the limiting structure 162, and surrounds the annular base 14. The first horizontal annular groove portion 168a of the first disk housing body portion 16a and the second horizontal annular groove portion 168b of the second disk housing body portion 16b form the horizontal annular groove 168 (as shown in FIG. 4C). In other words, the side wall structure 164, the cover plate 160, and the limiting structure 162 form the horizontal annular groove 168. The annular base 14 is embedded in the horizontal annular groove 168. The side wall structure 164 of the disk housing body 16 is a circular annular wall (as shown in FIG. 3A and FIG. 3B). In addition, the annular base 14 and the disk housing body 16 of the knob assembly 13 (as shown in FIG. 3A and FIG. 3B) in this implementation are sheet-like structures. To be specific, the annular base 14 is a hollow sheet-like annular base, and the disk housing body 16 is a hollow sheet-like disk housing body 16. However, the application is not limited thereto. Therefore, space occupied by the knob assembly 13 in the shuttle knob 1 is reduced, to dispose another element to add a function of the shuttle knob 1.

In this implementation, the second cover plate portion 160b of the second disk housing body portion 16b has a surface 1602b. The surface 1602b faces toward the second limiting portion 162b and faces the annular base 14. The surface 1602b includes at least one protruding rib 1604b. The protruding rib 1604b protrudes toward the second limiting portion 162b.

In this implementation, the second limiting portion 162b of the second disk housing body portion 16b has a surface 1620b (as shown in FIG. 4A and FIG. 4C) facing toward the second cover plate portion 160b, and the surface 1620b faces the annular base 14. The second limiting portion 162b also has a surface 1624b (as shown in FIG. 4A and FIG. 4C) facing the rotating shaft S. The surface 1620b includes at least one protruding rib 1622b protruding toward the second cover plate portion 160b. The surface 1624b includes at least one protruding rib 1626b protruding toward the rotating shaft S. In this implementation, the second cover plate portion 160b of the second disk housing body portion 16b includes a second slot 1600b, so that oil is capable of flowing into the disk housing body 16 through the second slot 1600b, to enable the disk housing body 16 and the annular base 14 to more smoothly rotate relative to each other, and reduce friction. The oil may be oil for lubrication.

In addition, quantities of protruding ribs 1622a and 1626a of the first limiting portion 162a and quantities of protruding ribs 1622b and 1626b of the second limiting portion 162b shown in FIG. 4A and a quantity of protruding ribs 1604a of the first cover plate portion 160a and a quantity of protruding ribs 1604b of the second cover plate portion 160b shown in FIG. 4c are only examples. The application is not limited to the quantities. In other implementations, any suitable quantities of protruding ribs 1604a, 1604b, 1622a, 1622b, 1626a, and 1626b can be applied to the application.

In this implementation, when assembly of the knob assembly 13 is completed, the limiting structure 162 is in slidable contact with an abutting surface 1460 of the annular base 14 by using the protruding rib 1622a of the first limiting portion 162a and the protruding rib 1622b of the second limiting portion 162b. In addition, the limiting structure 162 is in slidable contact with another abutting surface 1440 of the annular base 14 by using the protruding rib 1626a of the first limiting portion 162a and the protruding rib 1626b of the second limiting portion 162b. The cover plate 160 is in slidable contact with another abutting surface 1420 of the annular base 14 by using the protruding rib 1604a of the first cover plate portion 160a and the protruding rib 1604b of the second cover plate portion 160b. In this way, when the disk housing body 16 rotates relative to the annular base 14 along the rotating shaft S, because the disk housing body 16 comes into contact with the annular base 14 by using only the protruding ribs 1604a, 1604b, 1622a, 1622b, 1626a, and 1626b, a contact area between the disk housing body 16 and the annular base 14 can be reduced, and further friction generated when the disk housing body 16 rotates relative to the annular base 14 is reduced. In addition, the first slot 1600a and the second slot 1600b of the disk housing body 16 can also reduce the contact area between the disk housing body 16 and the annular base 14, and further reduce the friction generated when the disk housing body 16 rotates relative to the annular base 14.

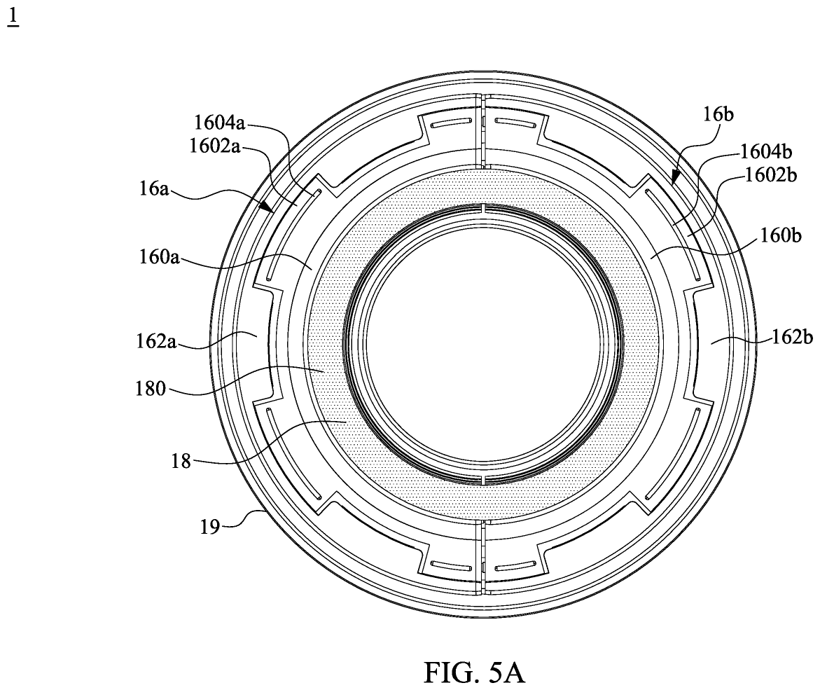

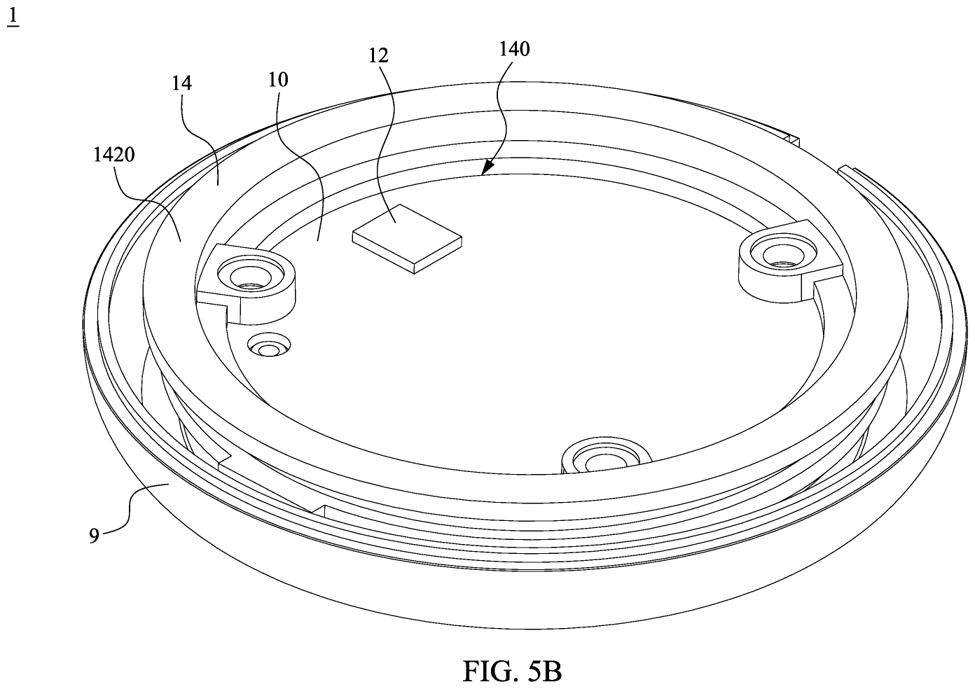

As shown in FIG. 2, FIG. 5A, and FIG. 5B, FIG. 5A is a three-dimensional view of the upper cover 19, the disk housing body 16, and the reflection layer 18. FIG. 5B is a three-dimensional view of the annular base 14, the detection apparatus 12, the substrate 10, and the base 9. The substrate 10 is a circuit board, is fixed to the base 9, and is configured to electrically connect to the detection apparatus 12. The detection apparatus 12 is disposed on the substrate 10. The knob assembly 13 is disposed on the substrate 10 by using the annular base 14.

As shown in FIG. 2, FIG. 4A, FIG. 4C, and FIG. 5A, the annular base 14 has an opening 140. The reflection layer 18 is disposed between the disk housing body 16 and the annular base 14. In this implementation, the reflection layer 18 is disposed on a surface that is of the cover plate 160 of the disk housing body 16 and that faces the annular base 14. The reflection layer 18 is an annular structure along the rotating shaft S and includes a feature pattern 180 (as shown in FIG. 5A). A position of the reflection layer 18 and a position of the opening 140 are overlapped. In some implementations, the feature pattern 180 on the reflection layer 18 may be designed to have different reflectivity at different positions. In this implementation, the detection apparatus 12 detects the feature pattern 180 of the reflection layer 18 through the opening 140 of the annular base 14 of the knob assembly 13. In this way, a reflected signal of the reflection layer 18 is received, and further calculation and determining are performed according to the reflected signal.

In this implementation, the substrate 10 includes a processor (not shown). The processor on the substrate 10 extracts the reflected signal received by the detection apparatus 12, to determine a frequency spectrum of the reflected signal. Based on the above, the disk housing body 16 rotates relative to the annular base 14 in the shuttle knob 1, so that the detection apparatus 12 is capable of receiving reflected signals generated, corresponding to different feature patterns 180, by the reflection layer 18. The different reflected signals may be designed to correspondingly have different commands or different selections, to enable a user to further operate a related electronic device by using the shuttle knob 1.

Refer to FIG. 2 to FIG. 5B. In this embodiment, in an assembly process of the shuttle knob 1, the reflection layer 18 may be disposed on a surface of the first cover plate portion 160a that faces the annular base 14, the annular base 14 is embedded in the first horizontal annular groove portion 168a of the first disk housing body portion 16a and the second horizontal annular groove portion 168b of the second disk housing body portion 16b. The reflection layer 18 is disposed on a surface of the second cover plate portion 160b that faces the annular base 14, so that the reflection layer 18 is disposed between the disk housing body 16 and the annular base 14. Then, the first end portion 16a1 and the second end portion 16a2 of the first disk housing body portion 16a are enabled to respectively connect to the first end portion 16b1 and the second end portion 16b2 of the second disk housing body portion 16b, so that assembly of the knob assembly 13 and the reflection layer 18 can be completed. In the foregoing structural configuration, because the position of the reflection layer 18 and the position of the opening 140 are overlapped, the reflection layer 18 is exposed toward the substrate 10 from the opening 140 of the annular base 14 shown in FIG. 3B. Then, the annular base 14 and the substrate 10 are locked onto the base 9 by using a fixing element, then the upper cover 19 shown in FIG. 2 is fixed to the base 9, so that assembly of the shuttle knob 1 is completed.

It should be noted that a person of ordinary skill in the art may learn that assembly of an additional element may be provided before, in, and after the foregoing assembly process of the shuttle knob 1. A part of the foregoing assembly process may alternatively be replaced or removed, and a sequence of steps of the assembly process may be changed.

It may be apparently learned from the detailed descriptions of specific implementations of the disclosure above that, the annular base in the knob assembly in the application is embedded in the horizontal annular groove portion of the disk housing body, so that assembly of the knob assembly can be completed, and further two working members respectively connected to the annular base and the disk housing body are enabled to rotate relative to each other without an additional assembly element. In this way, costs and assembly time of the shuttle knob are reduced. In addition, the annular base and the disk housing body of the knob assembly in this implementation are sheet-like structures. Therefore, the space occupied by the knob assembly in the shuttle knob is reduced, to dispose the another element to add the function of the shuttle knob.

Features of the foregoing plurality of implementations may enable a person of ordinary skill in the art better understand various aspects of the disclosure. A person of ordinary skill in the art should learn that, to achieve a same objective and/or a same advantage of the implementations of the disclosure, the disclosure may be used as a basis to further design or modify another process and structure. A person of ordinary skill in the art should learn that such an equivalent structure does not depart from the spirit and scope of the disclosure. A person of ordinary skill in the art may make various changes, replacements, and modifications herein without departing from the spirit and scope of the disclosure.

What is claimed is:

1. A knob assembly, comprising:
a disk housing body, comprising a cover plate, a limiting structure, and a side wall structure, wherein the cover plate and the limiting structure are disposed opposite to each other, and the side wall structure is connected to the cover plate and the limiting structure to form a horizontal annular groove; and
an annular base, embedded in the horizontal annular groove, so that the disk housing body is capable of rotating relative to the annular base.

2. The knob assembly according to claim 1, wherein the disk housing body comprises a first disk housing body portion and a second disk housing body portion, the first disk housing body portion and the second disk housing body portion are both C-shaped, the first disk housing body portion comprises one part of the cover plate, one part of the limiting structure, and one part of the side wall structure, the second disk housing body portion comprises the other part of the cover plate, the other part of the limiting structure, and the other part of the side wall structure, and the first disk housing body portion and the second disk housing body portion are detachably combined into the disk housing body.

3. The knob assembly according to claim 1, wherein the cover plate comprises at least one slot, so that oil is capable of flowing into the disk housing body through the slot.

4. The knob assembly according to claim 1, wherein a surface of the limiting structure that faces the annular base comprises at least one protruding rib, and the limiting structure is in slidable contact with the annular base by using the at least one protruding rib.

5. The knob assembly according to claim 1, wherein a surface of the cover plate that faces the annular base comprises at least one protruding rib, and the cover plate is in slidable contact with the annular base by using the at least one protruding rib.

6. The knob assembly according to claim 1, wherein the disk housing body is a hollow sheet-like disk housing body and the annular base is a hollow sheet-like annular base.

7. A shuttle knob, comprising:
a substrate;
a knob assembly, comprising:
a disk housing body, comprising a cover plate, a limiting structure, and a side wall structure, wherein the cover plate and the limiting structure are disposed opposite to each other, and the side wall structure is connected to the cover plate and the limiting structure to form a horizontal annular groove; and
an annular base, embedded in the horizontal annular groove, so that the disk housing body is capable of rotating relative to the annular base, wherein the knob assembly is disposed on the substrate by using the annular base;
a reflection layer, disposed between the disk housing body and the annular base, and comprising a feature pattern; and
a detection apparatus, disposed on the substrate, and configured to detect the feature pattern.

8. The shuttle knob according to claim 7, wherein the annular base of the knob assembly has an opening, and the detection apparatus detects the feature pattern through the opening.

9. The shuttle knob according to claim 7, wherein the reflection layer is an annular structure.

10. The shuttle knob according to claim 7, wherein the disk housing body comprises a first disk housing body portion and a second disk housing body portion, the first disk housing body portion and the second disk housing body portion are both C-shaped, the first disk housing body portion comprises one part of the cover plate, one part of the limiting structure, and one part of the side wall structure, the second disk housing body portion comprises the other part of the cover plate, the other part of the limiting structure, and the other part of the side wall structure, and the first disk housing body portion and the second disk housing body portion are detachably combined into the disk housing body.

11. The shuttle knob according to claim 7, wherein the cover plate comprises a slot, so that oil is capable of flowing into the disk housing body through the slot.

12. The shuttle knob according to claim 7, wherein a surface of the limiting structure that faces the annular base comprises at least one protruding rib, and the limiting structure is in slidable contact with the annular base by using the at least one protruding rib.

13. The shuttle knob according to claim 7, wherein a surface of the cover plate that faces the annular base comprises at least one protruding rib, and the cover plate is in slidable contact with the annular base by using the at least one protruding rib.

14. The shuttle knob according to claim 7, wherein the disk housing body is a hollow sheet-like disk housing body, and the annular base is a hollow sheet-like annular base.
